(19) United States
(12) Patent Application Publication
(10) Pub. No.: US 2025/0105636 A1
(43) Pub. Date: Mar. 27, 2025

(54) POWER DISTRIBUTION DEVICE

(71) Applicant: YAZAKI CORPORATION, Tokyo (JP)

(72) Inventors: Mitsuaki Morimoto, Susono-shi (JP); Hiroteru Kato, Susono-shi (JP); Michito Enomoto, Susono-shi (JP)

(21) Appl. No.: 18/826,481

(22) Filed: Sep. 6, 2024

(30) Foreign Application Priority Data
Sep. 25, 2023 (JP) 2023-160006

(51) Int. Cl. H02J 7/00; B60L 50/60; B60L 58/19

(52) U.S. Cl. CPC H02J 7/00304; B60L 50/66; B60L 58/19

(57) ABSTRACT

A power distribution device includes first to seventh lines, a first switch controlling conduction and interruption of the third line, a second switch controlling conduction and interruption of the fourth line, a third switch controlling conduction and interruption of the fifth line, a control unit controlling conductive states and interruption states of the first to third switches, a first fuse that is provided in the third line, a second fuse that is provided in the fourth line and that has a lower current carrying capacity than the first fuse, and a third fuse that is provided in the fifth line and that has a lower current carrying capacity than the first fuse.

### CROSS-REFERENCE TO RELATED APPLICATIONS

This application is based on and claims priority under 35 USC 119 from Japanese Patent Application No. 2023-160006 filed on Sep. 25, 2023, the entire content of which is incorporated herein by reference.

### TECHNICAL FIELD

The present disclosure relates to a power distribution device.

### BACKGROUND ART

In recent years, in consideration of the environment, electric vehicles including high-voltage batteries, such as an electric vehicle (EV) and a plug-in hybrid electric vehicle (PHEV), have appeared. The voltage of these electric vehicles is increasing year by year, for example, from approximately 400 V to approximately 800 V. As the voltage of the electric vehicles increases, the rated voltage of chargers for the electric vehicles is also increasing, which can be compatible with a vehicle including a high-voltage battery. However, since a charger having a high specification requires a large amount of power, it is difficult to provide the charger in a region with a poor power condition, and it is difficult to replace all currently provided chargers with the charger that can be compatible with a voltage of, for example, 800 V.

Therefore, a power distribution device has been proposed that allows switching between direct connection and parallel connection of secondary batteries mounted on an electric vehicle (for example, see JP2022-064408A). According to the power distribution device, by switching to the parallel connection at the time of charging, the voltage at the time of charging can be made lower than that in the case of series connection. Thus, the electric vehicle having a high voltage can be charged even with a low voltage.

Here, in the power distribution device described in JP2022-064408A, a short circuit may occur externally, such as on the load side or the charger side, and since the power distribution device switches between series connection and parallel connection, it is necessary to cope with the external short circuit in both connection states. The power distribution device described in JP2022-064408A also needs to protect against a battery short circuit that may occur when a failure occurs in a switch that switches between series connection and parallel connection. In particular, in order to deal with a failure in the switch, the power distribution device described in JP2022-064408A is provided with a fuse for each switch, and copes with the failure in the switch.

However, since the power distribution device described in JP2022-064408A is implemented such that paths pass through all secondary batteries, whether the paths are connected in series or in parallel, the fuse needs to be selected taking into account the maximum current. For example, when the current flow is 300 A in series and 100 A in parallel, a fuse that can be compatible with 300 A is required. Therefore, when an abnormality occurs in the parallel connection, the abnormal state has to be endured for a long time, and it is difficult to say that handling is appropriate.

Therefore, an object of the present disclosure is to provide a power distribution device that can switch between series connection and parallel connection of batteries and that can more appropriately cope with both an external short circuit and a battery short circuit.

### SUMMARY

According to the present disclosure, a power distribution device includes a first battery positive electrode terminal and a first battery negative electrode terminal that are respectively connected to a positive electrode and a negative electrode of a first battery, a second battery positive electrode terminal and a second battery negative electrode terminal that are respectively connected to a positive electrode and a negative electrode of a second battery, a charger positive electrode terminal and a charger negative electrode terminal that are respectively connected to a positive electrode and a negative electrode of a charger, a load positive electrode terminal and a load negative electrode terminal that are respectively connected to a positive electrode and a negative electrode of a load, a first line that connects the first battery positive electrode terminal and the charger positive electrode terminal, a second line that connects the second battery negative electrode terminal and the charger negative electrode terminal, a third line that connects the second battery positive electrode terminal and the first battery negative electrode terminal, a first switch configured to control conduction and interruption of the third line, a fourth line that connects the second battery positive electrode terminal and the first line, a second switch configured to control conduction and interruption of the fourth line, a fifth line that connects the second line and the first battery negative electrode terminal, a third switch configured to control conduction and interruption of the fifth line, a sixth line that connects a charger positive electrode terminal side of the first line with respect to a connection point between the first line and the fourth line with the load positive electrode terminal, a seventh line that connects a charger negative electrode terminal side of the second line with respect to a connection point between the second line and the fifth line with the load negative electrode terminal, a control unit configured to control conductive states and interruption states of the first switch, the second switch, and the third switch, a first fuse that is provided in the third line, a second fuse that is provided in the fourth line and that has a lower current carrying capacity than the first fuse, and a third fuse that is provided in the fifth line and that has a lower current carrying capacity than the first fuse.

According to the present disclosure, it is possible to provide a power distribution device that can switch between series connection and parallel connection of batteries and that can more appropriately cope with both an external short circuit and a battery short circuit.

### BRIEF DESCRIPTION OF DRAWINGS

FIG. 1 is a configuration diagram showing a secondary battery system including a power distribution device according to the present embodiment;

FIG. 2 is a block diagram showing details of a control unit shown in FIG. 1;

FIG. 3 is a first state diagram showing a control state attained by an SW control unit shown in FIG. 1;

FIG. 4 is a second state diagram showing a control state attained by the SW control unit shown in FIG. 1;

FIG. 5 is a state diagram showing the current flows in short circuit states, and shows the current flows when an external short circuit occurs on the charger side in series connection;

FIG. 6 is a state diagram showing the current flows in the short circuit states, and shows the current flows when an external short circuit occurs on the high-voltage load side in series connection;

FIG. 7 is a state diagram showing the current flows in the short circuit states, and shows the current flows when an external short circuit occurs on the charger side in parallel connection;

FIG. 8 is a state diagram showing the current flows in the short circuit states, and shows the current flows when a first battery is short-circuited;

FIG. 9 is a state diagram showing the current flows in the short circuit states, and shows the current flows when a second battery is short-circuited;

FIG. 10 is a configuration diagram showing a secondary battery system according to a modification of the present embodiment; and

FIG. 11 is a block diagram showing details of a control unit according to the modification shown in FIG. 10.

### DESCRIPTION OF EMBODIMENTS

Hereinafter, the present disclosure will be described with reference to a preferred embodiment. The present disclosure is not limited to the embodiment to be described below, and the embodiment can be appropriately changed without departing from the scope of the present disclosure. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

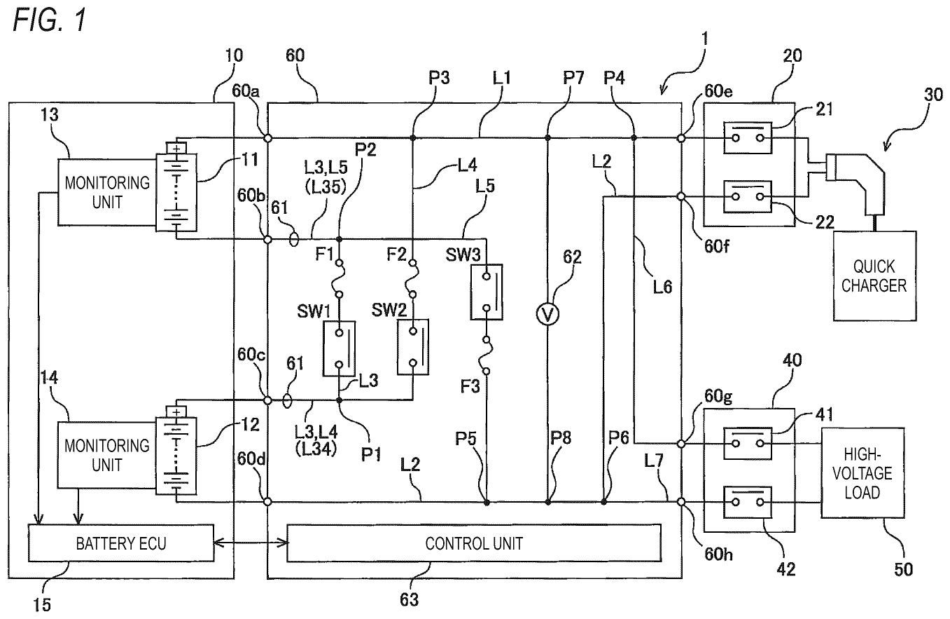

FIG. 1 is a configuration diagram showing a secondary battery system including a power distribution device according to the present embodiment. A secondary battery system 1 shown in FIG. 1 includes a high-voltage battery 10, a charging junction box (hereinafter referred to as J/B) 20, a quick charger (a charger) 30, a high-voltage J/B 40, a high-voltage load (a load) 50, and a power distribution device 60.

The high-voltage battery 10 includes a first battery 11, a second battery 12, a first monitoring unit 13, a second monitoring unit 14, and a battery electronic control unit (ECU) 15.

The first battery 11 and the second battery 12 are implemented by a rechargeable secondary battery such as a lithium ion battery. The first battery 11 and the second battery 12 are each capable of supplying a high voltage of, for example, 400 V in order to drive the high-voltage load 50 in an electric vehicle. In the present embodiment, the first battery 11 and the second battery 12 are assumed to have the same voltage.

The first monitoring unit 13 monitors the voltage, the current, and the temperature of the first battery 11. The second monitoring unit 14 monitors the voltage, the current, and the temperature of the second battery 12. The battery ECU 15 calculates the charging rates of the first battery 11 and the second battery 12 based on the information from the first monitoring unit 13 and the second monitoring unit 14. The battery ECU 15 may calculate the degree of deterioration of the first battery 11 and the second battery 12, detect an abnormality of the first battery 11 and the second battery 12, and the like.

The charging J/B 20 is a relay device interposed between the power distribution device 60 and the quick charger 30. The charging J/B 20 includes a first charging relay 21 and a second charging relay 22. The first charging relay 21 controls the connection between the positive electrode side of the quick charger 30 and the power distribution device 60. The second charging relay 22 controls the connection between the negative electrode side of the quick charger 30 and the power distribution device 60. The first charging relay 21 and the second charging relay 22 may be either of a mechanical contact type or a semiconductor type. The same applies to a first high-voltage relay 41, a second high-voltage relay 42, and a first switch SW1 to a third switch SW3 to be described later.

The quick charger 30 supplies power for charging the first battery 11 and the second battery 12 through the charging J/B 20 and the power distribution device 60. The quick charger 30 may supply, for example, power having a voltage of 400 V or power having a voltage of 800 V. The power distribution device 60 determines whether the first battery 11 and the second battery 12 are to be in the series state or the parallel state according to the supplied power, and charges the first battery 11 and the second battery 12 in the connected state. The secondary battery system 1 according to the present embodiment is assumed to be charged by the quick charger 30, but is not particularly limited thereto, and may be charged by a general charger that is not quick.

The high-voltage J/B 40 is a relay device interposed between the power distribution device 60 and the high-voltage load 50. The high-voltage J/B 40 includes a first high-voltage relay 41 and a second high-voltage relay 42. The first high-voltage relay 41 controls the connection between the positive electrode side of the high-voltage load 50 and the power distribution device 60. The second high-voltage relay 42 controls the connection between the negative electrode side of the high-voltage load 50 and the power distribution device 60. The high-voltage load 50 is a motor or the like that generates a driving force for the vehicle.

The power distribution device 60 sets the connection state of the first battery 11 and the second battery 12 to the series state or the parallel state at the time of charging from the quick charger 30 through the charging J/B 20 or at the time of discharging to the high-voltage load 50 through the high-voltage J/B 40.

The power distribution device 60 includes a plurality of terminals 60a to 60h. The first battery positive electrode terminal 60a and the first battery negative electrode terminal 60b are terminals that are connected to the positive electrode and the negative electrode of the first battery 11, respectively. The second battery positive electrode terminal 60c and the second battery negative electrode terminal 60d are terminals that are connected to the positive electrode and the negative electrode of the second battery 12, respectively. The charger positive electrode terminal 60e and the charger negative electrode terminal 60f are terminals that are connected to the positive electrode and the negative electrode of the quick charger 30, respectively. The load positive electrode terminal 60g and the load negative electrode terminal 60h are terminals that are connected to the positive electrode and the negative electrode of the high-voltage load 50, respectively.

Further, the power distribution device 60 includes a plurality of lines L1 to L7, a plurality of switches SW1 to SW3, a plurality of fuses F1 to F3, a plurality of current sensors 61, a voltage sensor 62, and a control unit 63.

The first line L1 connects the first battery positive electrode terminal 60a and the charger positive electrode terminal 60e. The second line L2 connects the second battery negative electrode terminal 60d and the charger negative electrode terminal 60f. The third line L3 connects the second battery positive electrode terminal 60c and the first battery negative electrode terminal 60b. As will be described later, one end side (from the terminal 60c to a connection point P1 in FIG. 1) of the third line L3 is shared with the fourth line L4, and the other end side (from the terminal 60b to a connection point P2 in FIG. 1) of the third line L3 is shared with the fifth line L5. The third line L3 connects the first battery negative electrode terminal 60b and the second battery positive electrode terminal 60c via common portions L34 and L35. The first switch SW1 controls conduction and interruption of the third line L3, and is provided at a position on the third line L3 excluding the common portions L34 and L35.

The fourth line L4 connects the second battery positive electrode terminal 60c and the first line L1. One end side of the fourth line L4 is the common portion L34 with the third line L3. The second switch SW2 controls conduction and interruption of the fourth line L4, and is provided at a position on the fourth line L4 excluding the common portion L34 with the third line L3.

The fifth line L5 connects the second line L2 and the first battery negative electrode terminal 60b. The other end side of the fifth line L5 is the common portion L35 with the third line L3. The third switch SW3 controls conduction and interruption of the fifth line L5, and is provided at a position on the fifth line L5 excluding the common portion L35 with the third line L3.

The sixth line L6 connects a connection point P4 of the first line L1, which is located on the charger positive electrode terminal 60e side with respect to a connection point P3 with the fourth line L4, to the load positive electrode terminal 60g. The seventh line L7 connects a connection point P6 of the second line L2, which is located on the charger negative electrode terminal 60f side with respect to a connection point P5 with the fifth line L5, to the load negative electrode terminal 60h.

A first fuse F1 to a third fuse F3 are mechanical fuses that melt when an overcurrent flows. Among these fuses F1 to F3, the second fuse F2 and the third fuse F3 have a lower current carrying capacity than the first fuse F1. Here, the first fuse F1 is provided on the third line L3, in particular, at a position excluding the common portions L34 and L35 in the third line L3. The second fuse F2 is provided on the fourth line L4, in particular, at a position excluding the common portion L34 in the fourth line L4. Further, the third fuse F3 is provided on the fifth line L5, in particular, at a position excluding the common portion L35 in the fifth line L5. Specifically, in the present embodiment, the first fuse F1 is provided on the first battery negative electrode terminal 60b side with respect to the first switch SW1. The second fuse F2 is provided on the connection point P3 side with respect to the second switch SW2. The third fuse F3 is provided on the connection point P5 side with respect to the third switch SW3.

The current sensors 61 are provided on the fourth line L4 and the fifth line L5, and output a signal corresponding to a current in the fourth line L4 and a signal corresponding to a current in the fifth line L5. In the present embodiment, the current sensors 61 are provided on the common portion L34 between the third line L3 and the fourth line L4 and the common portion L35 between the third line L3 and the fifth line L5.

The voltage sensor 62 outputs a signal corresponding to a potential difference between the first line L1 and the second line L2. More specifically, the voltage sensor 62 outputs a signal corresponding to a potential difference between a connection point P7 located between the connection point P3 and the connection point P4 on the first line L1, and a connection point P8 located between the connection point P5 and the connection point P6 on the second line L2.

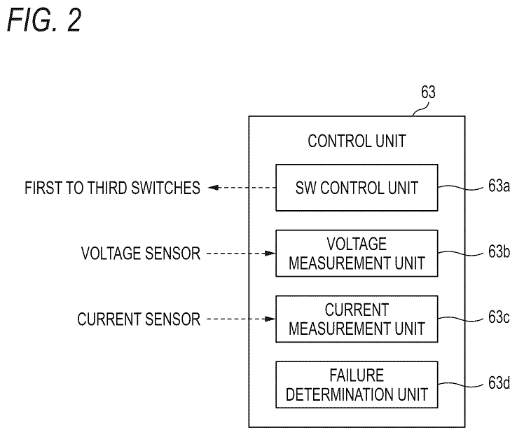

FIG. 2 is a block diagram showing details of the control unit 63 shown in FIG. 1. The control unit 63 controls the entire power distribution device 60, and includes a SW control unit 63a, a voltage measurement unit 63b, a current measurement unit 63c, and a failure determination unit 63d.

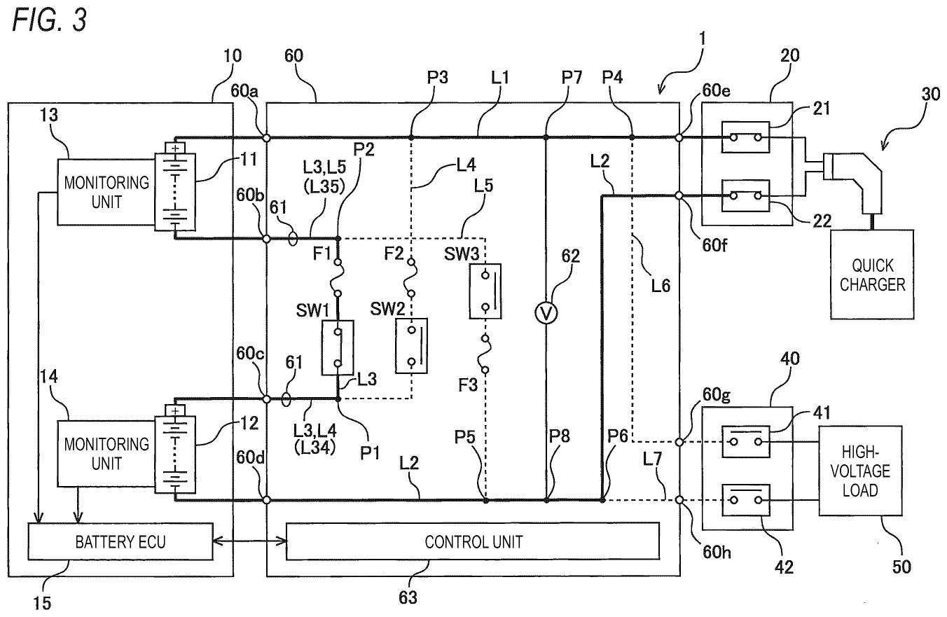

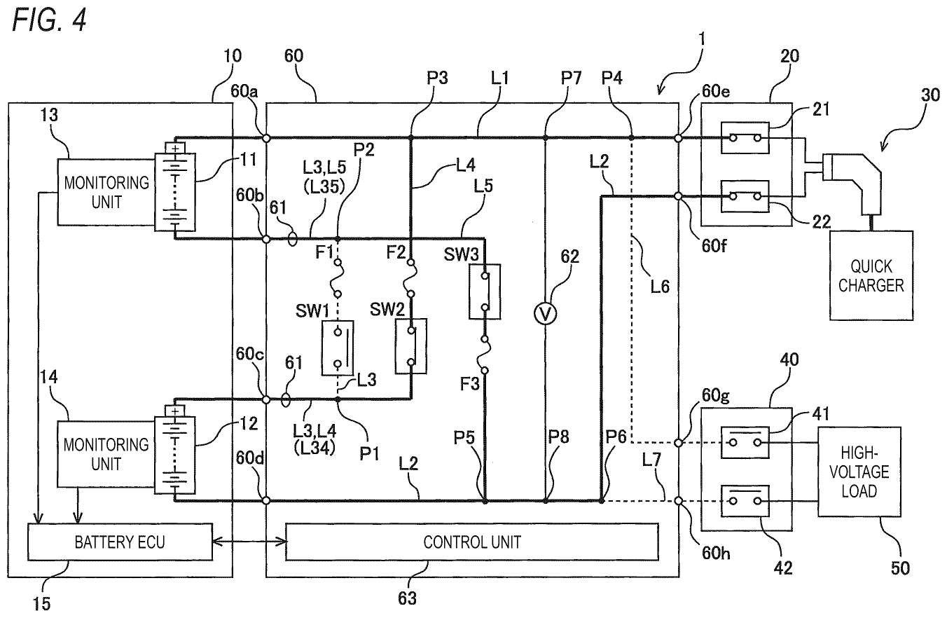

The SW control unit 63a controls the conduction state (ON) and the interruption state (OFF) of the first switch SW1, the second switch SW2, and the third switch SW3. FIGS. 3 and 4 are state diagrams showing control states attained by the SW control unit 63a shown in FIG. 2. First, as shown in FIG. 3, when it is desired to connect the first battery 11 and the second battery 12 in series, the SW control unit 63a turns on the first switch SW1 and turns off the second switch SW2 and the third switch SW3. Accordingly, for example, at the time of charging, a route (see a thick line) of the first line L1, the first battery 11, the third line L3, the second battery 12, and the second line L2 is formed. Thus, the first battery 11 and the second battery 12 are connected in series. On the other hand, as shown in FIG. 4, when it is desired to connect the first battery 11 and the second battery 12 in parallel, the SW control unit 63a turns off the first switch SW1 and turns on the second switch SW2 and the third switch SW3. Accordingly, at the time of charging, a route (see a thick line) of the first line L1, the first battery 11, the fifth line L5, and the second line L2 and a route (see a thick line) of the first line L1, the fourth line L4, the second battery 12, and the second line L2 are formed. Thus, the first battery 11 and the second battery 12 are connected in parallel.

The voltage measurement unit 63b measures a voltage corresponding to the potential difference between the first line L1 and the second line L2 according to the signal from the voltage sensor 62. The current measurement unit 63c measures a current in the fourth line L4 (in particular, the common portion L34) and a current in the fifth line L5 (in particular, the common portion L35) according to the signal from the current sensor 61.

The failure determination unit 63d determines a failure such as an external short circuit or a battery short circuit. The failure determination unit 63d determines, based on the voltage measured by the voltage measurement unit 63b and the current measured by the current measurement unit 63c, an external short circuit on the quick charger 30 side or the high-voltage load 50 side, or a battery short circuit when the first switch SW1, the second switch SW2, and the third switch SW3 have a failure.

For example, in a case in which an external short circuit occurs when the first battery 11 and the battery 12 are connected in series, an overcurrent flows in the third line L3. In a case in which an external short circuit occurs when the first battery 11 and the battery 12 are connected in parallel, an overcurrent flows in the fourth line L4 and the fifth line L5. Further, when a battery short circuit occurs in the first battery 11 or the second battery 12, an overcurrent flows in a certain location. The failure determination unit 63d determines whether there is such a tendency of the current based on the measurement result of the current measurement unit 63c, and determines an external short circuit or a battery short circuit.

The failure determination unit 63d according to the present embodiment can determine the failure in the first switch SW1, the second switch SW2, and the third switch SW3 based on the measurement result of the current measurement unit 63c and the measurement result of the voltage measurement unit 63b. An ON failure in which the first switch SW1, the second switch SW2, and the third switch SW3 are always on and an OFF failure in which the first switch SW1, the second switch SW2, and the third switch SW3 are always off may occur. The failure determination unit 63d can determine such a failure. For example, it is assumed that the SW control unit 63a detects a voltage of 400 V in the voltage measurement unit 63b although all the switches SW1 to SW3 are turned off. In this case, it can be said that one of the second switch SW2 and the third switch SW3 has the ON failure. The failure determination unit 63d determines a failure based on such voltage measurement. Further, in this case, for example, when the current measurement unit 63c measures a predetermined current in the common portion L34 and detects zero current in the common portion L35, the failure determination unit 63d identifies an ON failure in the second switch SW2.

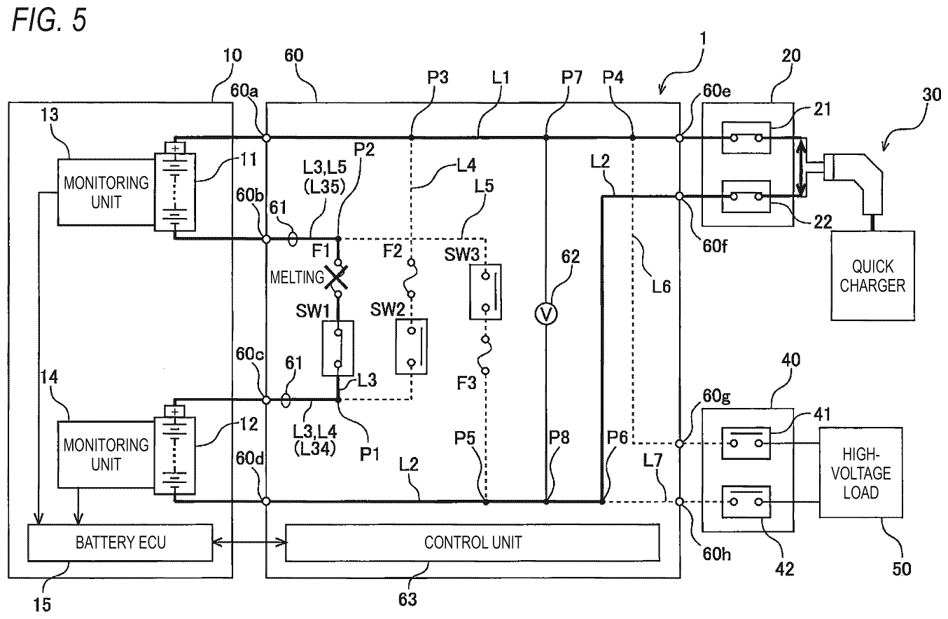

Next, the operation according to the present embodiment will be described. FIGS. 5 to 9 are state diagrams showing the current flows in the short circuit states.

First, as shown in FIG. 5, it is assumed that an external short circuit occurs on the quick charger 30 side at the time of series connection. In this case, an overcurrent flows through the route of the first line L1, the first battery 11, the third line L3, the second battery 12, and the second line L2. In this case, since the first fuse F1 is provided in the third line L3, it is possible to appropriately cope with an external short circuit on the quick charger 30 side at the time of series connection by melting the first fuse F1.

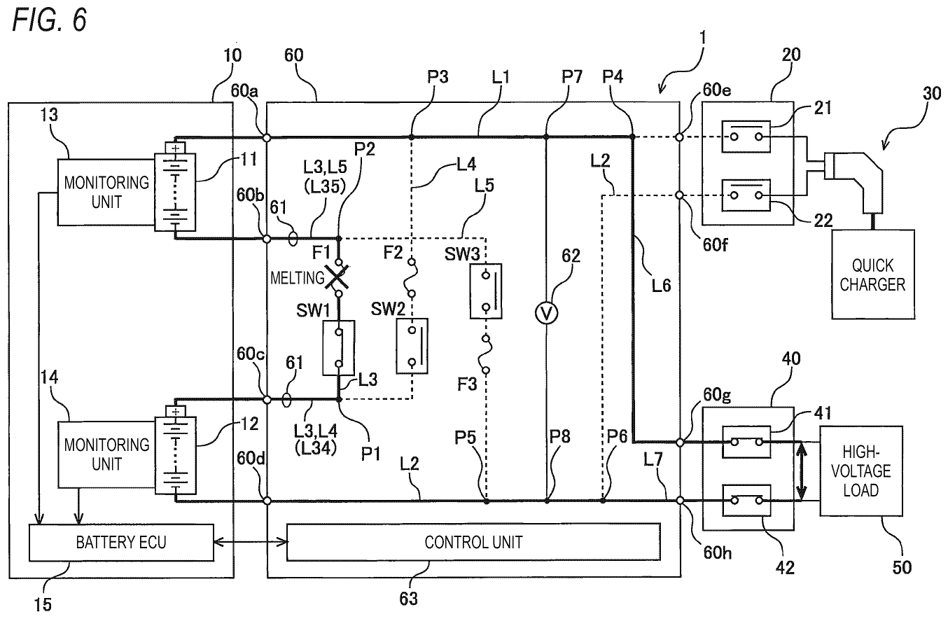

As shown in FIG. 6, it is assumed that an external short circuit occurs on the high-voltage load 50 side at the time of series connection. In this case, an overcurrent flows through the route of the sixth line L6, the first line L1 (from the first battery positive electrode terminal 60a to the connection point P4), the first battery 11, the third line L3, the second battery 12, the second line L2 (from the second battery negative electrode terminal 60d to the connection point P6), and the seventh line L7. In this case, since the first fuse F1 is provided in the third line L3, it is also possible to appropriately cope with an external short circuit on the high-voltage load 50 side at the time of series connection by melting the first fuse F1.

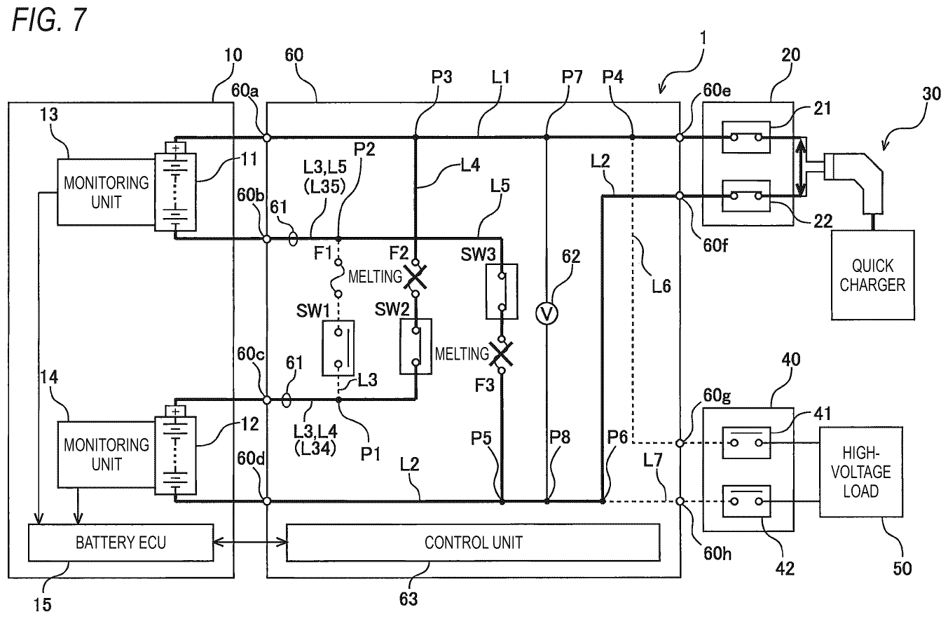

Further, as shown in FIG. 7, it is assumed that an external short circuit occurs on the quick charger 30 side at the time of parallel connection. In this case, an overcurrent flows through both the route from the first line L1, the first battery 11, the fifth line L5, and the second line L2 (from the connection point P5 to the charger negative electrode terminal 60f) and the route from the first line L1 (from the connection point P3 to the charger positive electrode terminal 60e), the fourth line L4, the second battery 12, and the second line L2. In this case, since the second fuse F2 is provided in the fourth line L4 and the third fuse F3 is provided in the fifth line L5, it is possible to appropriately cope with an external short circuit on the quick charger 30 side at the time of parallel connection by melting both the fuses F2 and F3.

In the present embodiment, it is assumed that parallel connection is performed only at the time of charging, but the present disclosure is not particularly limited thereto. In a case in which parallel connection is performed when the high-voltage load 50 is operated, it is possible to cope with an external short circuit on the high-voltage load 50 side in the same manner.

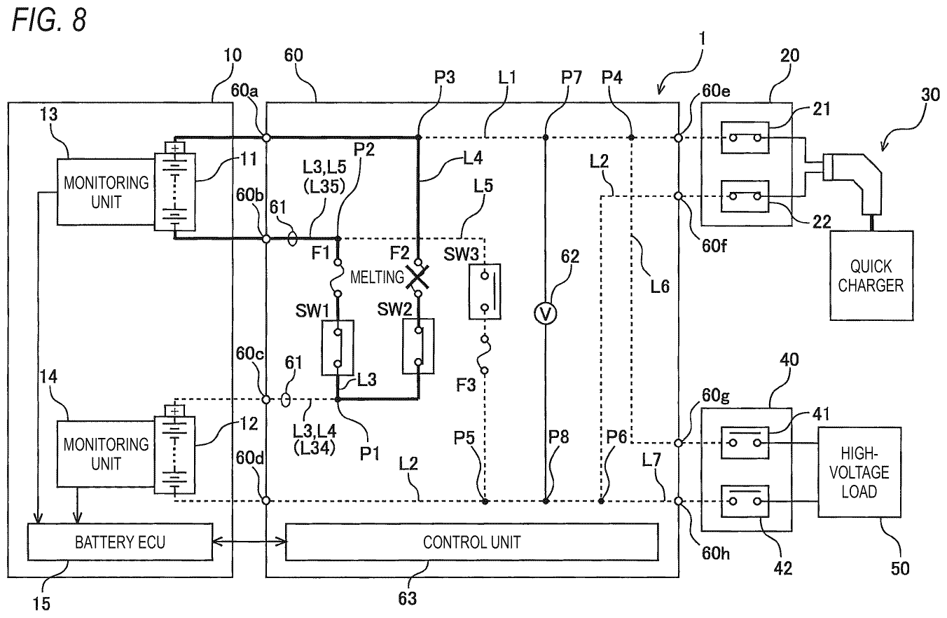

As shown in FIG. 8, it is assumed that, for example, when the second switch SW2 has an ON failure, the SW control unit 63a attempts to perform series connection. In this case, a route of the first line L1 (from the first battery positive electrode terminal 60a to the connection point P3), the first battery 11, the third line L3 (from the first battery negative electrode terminal 60b to the connection point P1), and the fourth line L4 (from the connection point P1 to the connection point P3) is formed, and a battery short circuit occurs. Thus, an overcurrent flows on the route. Here, since the first fuse F1 and the second fuse F2 are provided on the route, the second fuse F2, which has a lower current carrying capacity, melts relatively early. Thus, it is possible to appropriately cope with a battery short circuit of the first battery 11.

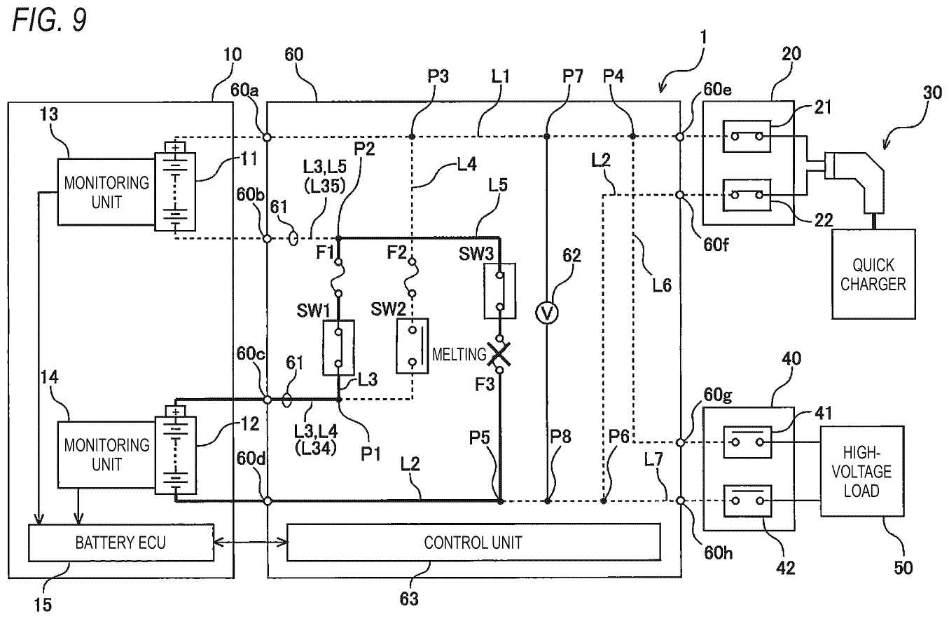

Further, as shown in FIG. 9, it is assumed that, for example, when the third switch SW3 has an ON failure, the SW control unit 63a attempts to perform series connection. In this case, a route of the third line L3 (from the connection point P2 to the second battery positive electrode terminal 60c), the second battery 12, the second line L2 (from the second battery negative electrode terminal 60d to the connection point P5), and the fifth line L5 (from the connection point P5 to the connection point P2) is formed, and a battery short circuit occurs. Thus, an overcurrent flows on the route. Here, since the first fuse F1 and the third fuse F3 are provided on the route, the third fuse F3, which has a lower current carrying capacity, melts relatively early. Thus, it is possible to appropriately cope with a battery short circuit of the second battery 12.

In this way, according to the power distribution device 60 in the present embodiment, since the circuit described above is constructed, when series connection is desired, the first switch SW1 is turned on, and the second switch SW2 and the third switch SW3 are turned off. In this case, the first fuse F1 is interrupted at the time of an external short circuit, and it is possible to appropriately cope with the external short circuit at the time of series connection.

Since the circuit described above is constructed, when parallel connection is desired, the first switch SW1 is turned off, and the second switch SW2 and the third switch SW3 are turned on. In this case, both the second fuse F2 and the third fuse F3 are interrupted at the time of an external short circuit. In particular, since the current carrying capacity of the second fuse F2 and the third fuse F3 is lower than that of the first fuse F1, the time until the interruption in the external short circuit at the time of parallel connection is less likely to become long, and it is possible to appropriately cope with the external short circuit at the time of parallel connection.

Further, when a failure occurs in which the first switch SW1 and the second switch SW2 are both turned on due to a switch failure, a route is formed from the positive electrode of the first battery 11 through the second fuse F2 and the first fuse F1 in this order to the negative electrode of the first battery 11. In this case, of the first fuse F1 and the second fuse F2, the second fuse F2 is interrupted that has the lower current carrying capacity, and it is possible to appropriately cope with a battery short circuit on the first battery 11 side.

In addition, when a failure occurs in which the first switch SW1 and the third switch SW3 are both turned on due to a switch failure, a route is formed from the positive electrode of the second battery 12 through the first fuse F1 and the third fuse F3 in this order to the negative electrode of the second battery 12. In this case, of the first fuse F1 and the third fuse F3, the third fuse F3 is interrupted that has the lower current carrying capacity, and it is possible to appropriately cope with a battery short circuit on the second battery 12 side.

As described above, it is possible to provide the power distribution device 60 that can switch between series connection and parallel connection of the batteries 11 and 12 and that can more appropriately cope with both an external short circuit and a battery short circuit.

Since the common portions L34 and L35 are provided, a part of the third line L3 and the fourth line L4 and a part of the third line L3 and the fifth line L5 can be made common to contribute to simplification of the circuit. Further, the first fuse F1 to the third fuse F3 are provided at positions other than the common portions L34 and L35, and the fuses F1 to F3 can be provided at appropriate positions.

Although the present disclosure is described above based on the embodiment, the present disclosure is not limited to the above embodiment, a modification may be made without departing from the gist of the present disclosure, and the known or well-known techniques may be combined.

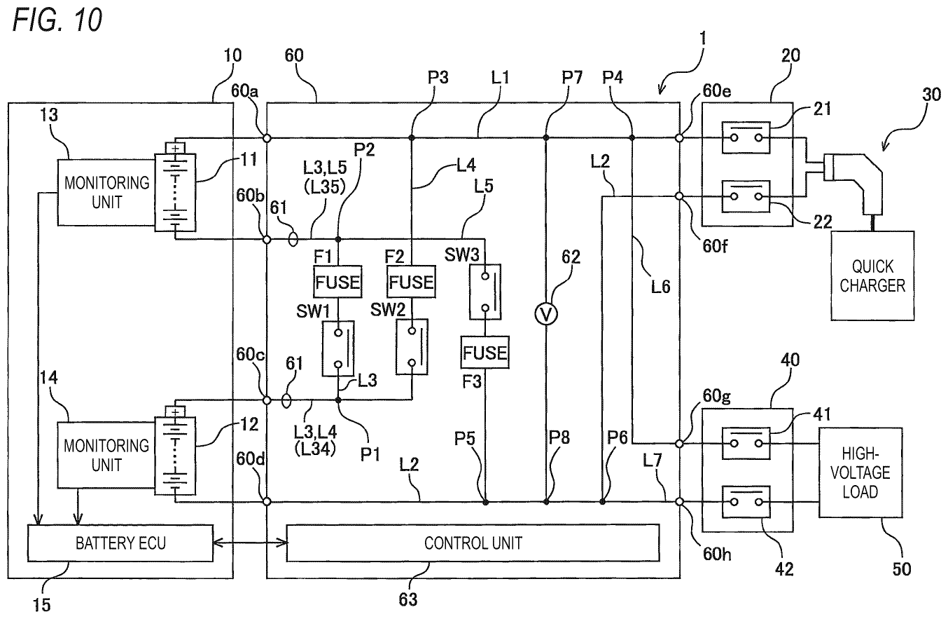

FIG. 10 is a configuration diagram showing the secondary battery system 1 according to a modification of the present embodiment. In the modification shown in FIG. 10, in the power distribution device 60, the first fuse F1, the second fuse F2, and the third fuse F3 are not mechanical fuses that melt due to an overcurrent, but are electronic fuses such as a pyro-fuse or a semiconductor fuse. In particular, in the present embodiment, the first fuse F1, the second fuse F2, and the third fuse F3 can be interrupted in response to a signal from the outside.

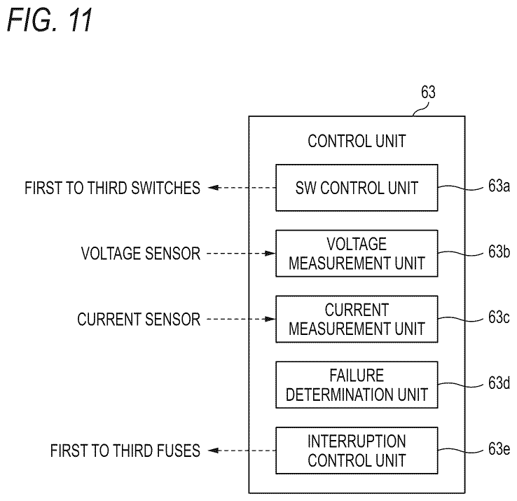

FIG. 11 is a block diagram showing details of the control unit 63 according to the modification shown in FIG. 10. As shown in FIG. 11, the control unit 63 includes an interruption control unit 63e. The interruption control unit 63e can selectively interrupt the first electronic fuse F1 to the third electronic fuse F3, and transmits a signal to one of the first fuse F1 to the third fuse F3 to be interrupted. Here, when an external short circuit occurs at the time of series connection shown in FIGS. 5 and 6, an overcurrent flows through both the common portions L34 and L35. Therefore, when a current (a current lower than the overcurrent) larger than that in the normal state flows through both the common portions L34 and L35 by the current measurement unit 63c, the failure determination unit 63d can determine an external short circuit. Then, in such a case, the interruption control unit 63e determines that an overcurrent flows in the future and interrupts the first fuse F1. Similarly, in the external short circuit shown in FIG. 7, the interruption control unit 63e interrupts the second fuse F2 and the third fuse F3. In addition, the interruption control unit 63e interrupts the second fuse F2 or the third fuse F3 in the same manner for the battery short circuit.

In this way, in the modification, the currents in the common portion L34 and the common portion L35 are measured, and the first fuse F1, the second fuse F2, and the third fuse F3, which are electronic fuses, are selectively interrupted by the interruption control unit 63e. Therefore, unlike the mechanical fuse, at the time of interruption, there is no requirement that an overcurrent flows, so that it is possible to detect an abnormality before an overcurrent flows, and it is possible to interrupt the appropriate location.

In the above, the first fuse F1 is provided on the third line L3 on the first battery negative terminal 60b side with respect to the first switch SW1, but the present disclosure is not particularly limited thereto. Alternatively, the first fuse F1 may be provided on the second battery positive terminal 60c side. Similarly, the second fuse F2 may be provided on the connection point P1 side with respect to the second switch SW2. Further, the third fuse F3 may be provided on the connection point P2 side with respect to the third switch SW3.

What is claimed is:

1. A power distribution device comprising:
a first battery positive electrode terminal and a first battery negative electrode terminal that are respectively connected to a positive electrode and a negative electrode of a first battery;
a second battery positive electrode terminal and a second battery negative electrode terminal that are respectively connected to a positive electrode and a negative electrode of a second battery;
a charger positive electrode terminal and a charger negative electrode terminal that are respectively connected to a positive electrode and a negative electrode of a charger;
a load positive electrode terminal and a load negative electrode terminal that are respectively connected to a positive electrode and a negative electrode of a load;
a first line that connects the first battery positive electrode terminal and the charger positive electrode terminal;
a second line that connects the second battery negative electrode terminal and the charger negative electrode terminal;
a third line that connects the second battery positive electrode terminal and the first battery negative electrode terminal;
a first switch configured to control conduction and interruption of the third line;
a fourth line that connects the second battery positive electrode terminal and the first line;
a second switch configured to control conduction and interruption of the fourth line;
a fifth line that connects the second line and the first battery negative electrode terminal;
a third switch configured to control conduction and interruption of the fifth line;
a sixth line that connects a charger positive electrode terminal side of the first line with respect to a connection point between the first line and the fourth line with the load positive electrode terminal;
a seventh line that connects a charger negative electrode terminal side of the second line with respect to a connection point between the second line and the fifth line with the load negative electrode terminal;
a control unit configured to control conductive states and interruption states of the first switch, the second switch, and the third switch;
a first fuse that is provided in the third line;
a second fuse that is provided in the fourth line and that has a lower current carrying capacity than the first fuse; and
a third fuse that is provided in the fifth line and that has a lower current carrying capacity than the first fuse.

2. The power distribution device according to claim 1,
wherein, when one end side of the fourth line is shared with the third line and is connected to the second battery positive electrode terminal and one end side of the fifth line is shared with the third line and is connected to the first battery negative electrode terminal, the first fuse is provided at a position in the third line other than a common portion between the fourth line and the fifth line, the second fuse is provided at a position in the fourth line other than a common portion with the third line, and the third fuse is provided at a position in the fifth line other than a common portion with the third line.

3. The power distribution device according to claim 2,
wherein the first fuse, the second fuse, and the third fuse are electronic fuses configured to be interrupted in response to a signal from an outside, and
wherein the control unit includes a current measurement unit configured to measure currents in a common portion between the third line and the fourth line and a common portion between the third line and the fifth line, and an interruption control unit configured to selectively interrupt the first fuse, the second fuse, and the third fuse based on the currents measured by the current measurement unit.
